(19) United States
(12) Patent Application Publication
(10) Pub. No.: US 2025/0230905 A1
(43) Pub. Date: Jul. 17, 2025

(54) DEVICE FOR PREVENTING ACCUMULATION OF FLAMMABLE FLUID IN MANHOLES CONTAINING LINE VALVES

(71) Applicants: ISIF S.R.L., Castelfranco Piandisco (IT); INRETE Distribuzione Energia S.p.A., Bologna (IT)

(72) Inventor: Mauro Odori, Castelfranco Piandisco (IT)

(21) Appl. No.: 18/853,604

(22) PCT Filed: Apr. 1, 2023
(86) PCT No.: PCT/IB2023/053296

§ 371 Date: Oct. 2, 2024

(30) Foreign Application Priority Data
Apr. 6, 2022 (IT) 102022000006863

(51) Int. Cl. F17D 5/02

(52) U.S. Cl. CPC F17D 5/02

(57) ABSTRACT

The device (100) prevents the accumulation of flammable gas, vapor or mist in a manhole (P) which houses a ball valve (Vs) of a pipeline (T) carrying flammable fluids. The ball valve (Vs) is periodically closed and reopened in an automatic manner by motorized means (2) of a known system (1). The device (100) includes: a ventilation box (102) communicating with the external environment; a vent duct (101) that connects the inside of the manhole with the outside atmosphere; a gas sensor (103), intended to signal the possible presence of flammable gases, so that the closing/opening maneuver of said ball valve (Vs) is inhibited. The device (100) allows the system (1) to be validated in risk class ‘2’, or as a ‘safe space’, according to ATEX regulations, instead of the more restrictive risk class ‘0’.

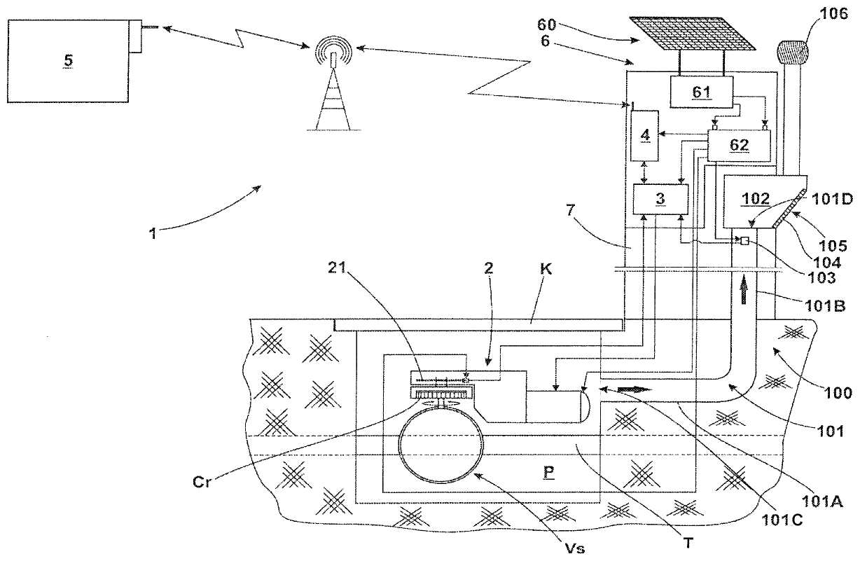

### TECHNICAL FIELD

The present invention relates to the technical field of networks for transporting and distributing fluids, in particular flammable fluids such as gas pipelines, oil pipelines and the like.

### BACKGROUND ART

Very often, pipelines forming these networks extend for kilometers and branch off in multiple directions covering even very large territorial extensions.

Line valves, which are usually, though not necessarily, of the ball-type, are located along the above-mentioned pipelines to section off certain parts of the corresponding network and/or to stop the flow of fluid downstream of a certain point, e.g. for maintenance purposes.

The dimensions of these line valves are proportional to the diameter of the associated pipelines, which can vary, roughly, between four and sixteen inches.

In many cases, the pipelines of a transport or distribution network are located below ground level, and each line valve is accessible from an associated inspection manhole, closed for example by a manhole cover.

Under normal operating conditions of the respective fluid distribution network, the line valves are in the open position and this condition may persist for even very long periods of time, several months if not years.

### Technical Problem

This prolonged immobility of the valves almost certainly leads to their blockage. To avoid this, the companies managing the distribution networks have been obliged to carry out a periodic movement cycle, usually at least every 1-2 months.

In order to perform this cycle, and to maintain the correct manoeuvrability of the valves, one or more employees may be sent periodically to inspect each valve and maneuver it to partially close it and then, immediately afterwards, to completely reopen it.

As can be easily understood, such a procedure presents many drawbacks, in terms of manpower, timing, costs, scheduling requirements, and sometimes logistics, as it is not uncommon for at least some of the line valves in a transport or distribution network to be located in places that are difficult to access, for a variety of reasons.

In order to overcome these drawbacks, the same Applicant filed a Italian National Patent Application for Industrial Invention No.

102020000026648, subsequently filed as a PCT application under No. PCT/IB2021/060357, in which a “Method and system for automatic operation and functional verification of line valves installed in fluid distribution networks” is described and claimed in the corresponding US National Stage Patent Application Publication No. 2024/0011577 A1 published Jan. 11, 2024.

The above-mentioned system is aimed at automatically maneuvering the line valves (e.g., ball valves), thus avoiding the need to physically go to where they are located.

Each ball valve is controlled by a gear motor unit, which is controlled by a sensor element that sends data to an electronic processing and control which unit, is responsible for activating/deactivating said gear motor unit, according to an operation program for the ball valve, which partially close it and subsequently immediately reopen it at predefined time intervals. Said electronic processing and control unit sends a report to a remote operation center concerning the outcome of the carried out maneuver, by means of a transceiver apparatus.

In the above drawings and description, the most frequent configuration of installation of the system has been considered, in which the pipeline is buried, and the ball valve is housed in an inspection manhole closed by a manhole cover.

To make the system energy independent, a photovoltaic panel, a battery charger and an accumulator are located above the ground near the manhole.

The above-mentioned system is fully satisfactory from a functional point of view, but like all equipment that must be placed on the market, it was necessary to verify compliance with the safety regulations that apply to both the components of the system and the site of its installation.

In particular, for this last aspect, the regulations pertaining to the flammability and explosion risks of atmospheres in which flammable gases, vapors and mists are present were considered.

The main regulatory references are those of Directive 1999/92/EC (ATEX) and CEI EN 60079-10-1:2021-09; according to the parameters contained in the cited standards, a zone can fall into:
class 0—maximum danger due to high probability of the presence of an explosive atmosphere.
class 1—medium danger due to occasional probability of the presence of an explosive atmosphere;
class 2—low danger due to unlikely or exceptional presence, for short periods, of an explosive atmosphere.
safe space—non-dangerous environment as there is no accumulation of explosive substances.

Upon the verification carried out under the given conditions, the environment of the manhole is considered in class 0, due to the presence of an electrically operated gear motor unit in a compartment of limited cubic capacity, such as the above mentioned manhole: in fact, any leakage, even a very small one, of gas or other flammable fluid from the ball valve or from some joint due to an imperfect seal could easily saturate the manhole environment, so that, as can easily be guessed, a spark caused by the electric motor would trigger a detonation in the manhole with potentially very serious consequences.

Obviously, such a classification is very penalizing for the marketing of such a system, even though, in practice, the envisaged explosive events are extremely rare and improbable, since the ball valves and all the components that allow their connection to the pipes are constructed in such a way as to guarantee tightness at the highest safety levels.

### OBJECTS OF THE INVENTION

The technical problem addressed within the scope of the present invention is to overcome the critical issues which make the system, installed in a manhole, fall into the worst risk class, by proposing to combine the system with a device for the prevention of accumulation of flammable fluid in the atmosphere inside the manhole, so that greater safety and a better classification of the residual risk can be obtained.

Another object of the invention is to provide a technically simple and functionally effective device that can operate properly without the need for frequent maintenance.

A still further object of the invention is to propose a device that can, if necessary, interact with the operation of the system in such a way as to avoid any risk of detonation and can therefore comply with regulations with an even more favourable risk classification.

A further object of the invention is to realize a low cost device, which does not significantly affect the total cost of the system and its installation on site.

### SUMMARY OF THE INVENTION

These and other objects are fully achieved by means of a device for preventing accumulation of flammable fluid in manholes housing line valves installed in pipelines of a network for transporting said flammable fluids, with each of said line valves, for example ball valves, being kept in an open configuration under normal operating conditions of the respective network and associated with a system which includes: a gear motor unit for motorized closing and opening of said ball valve; an electronic processing and control unit, aimed at determining the activation/deactivation of said gear motor unit, in accordance with pre-defined modes; a RF operated transceiver apparatus interfaced with said electronic processing and control unit and intended to dialog with a remote operating center, to send to the latter a report concerning the outcome of each single closing and opening maneuver of the respective ball valve.

The above-mentioned device includes:
a ventilation box situated above the ground and communicating with the external environment;
at least one vent duct, extending from the inside of the corresponding manhole in which said ball valve is housed to the above-mentioned ventilation box;
at least one gas sensor, placed in a predetermined position between said manhole and said ventilation box, interfaced with said electronic processing and control unit and intended to signal the possible presence of flammable gases or vapors in the monitored air volume to said unit, so that the closing/opening maneuver of said ball valve is inhibited by said gear motor unit.

### BRIEF DESCRIPTION OF THE DRAWING

The characteristics of the invention will be apparent from the following description of a preferred embodiment of the device for preventing accumulation of flammable fluid in the manholes which house the line valves installed in pipelines of a network for transporting said flammable fluids, in accordance with the content of the claims and with the help of the enclosed drawing, in which the sole FIGURE illustrates an overall schematic view of the claimed device, combined with a known system for motorized movement of a line ball valve housed in a manhole.

### DESCRIPTION OF EMBODIMENTS OF THE INVENTION

In the above mentioned sole FIGURE, the device proposed by the present invention, as a whole, has been indicated by the reference number 100.

The task of the device 100 is to prevent accumulation of flammable fluids, such as gases, vapors, and mists in housing manholes P of line valves, for example ball valves Vs, installed in pipelines T of a network for transporting said flammable fluids, i.e., methane gas, oil or petroleum products.

The housing manhole P is normally closed by a removable manhole cover K.

As already mentioned in the introductory note, said ball valves Vs are kept in open configuration under normal operating conditions of the respective network and, in order to avoid their blocking caused by too prolonged inactivity of the closing means, the latter are periodically moved automatically by means of the system 1, which implements the method set forth in the above mentioned prior art documents filed by the same Applicant.

The system 1, according to the teachings set forth in the cited documents, comprises, among other things:
a gear motor unit 2, aimed at closing and opening said ball valve Vs, acting on a rotation control Cr external to the body of said valve Vs;
a first sensor element 21, connected to said gear motor unit 2, aimed at detecting the angular amplitude and the direction of the rotation imposed to said rotation control Cr of said ball valve Vs;
an electronic processing and control unit 3, aimed at determining the activation/deactivation of said gear motor unit 2, according to pre-defined modes, and at receiving in feedback the signals provided by said sensor unit or element 21;
a RF operated transceiver apparatus 4 interfaced with said electronic processing and control unit 3 and intended to dialog with a remote operating center 5, to send to the latter a report relating to the outcome of each single closing and opening maneuver of the respective ball valve Vs.

The system 1 does not depend on external energy supply thanks to an associated power supply module 6 which includes at least one photovoltaic panel 60, a battery charger 61 and at least one accumulator 62.

Said module 6, together with the electronic processing and control unit 3 and the transceiver apparatus 4 are preferably supported by a column 7 located above the ground, near the manhole P.

It is specified that in the enclosed FIGURE the column 7 is cut in the height direction, as it would not be proportional to the other shown elements, for the reasons set out below.

According to the invention, at least one vent duct 101 is provided in the device 100, said vent duct starting from a wall of said manhole P in which said ball valve Vs is housed, and extending underground for a first length 101A, almost horizontal, and then curving and continuing substantially vertically for a second length 101B, until flowing into a ventilation box 102 arranged above the ground and communicating with the external environment.

The vent duct 101 is open at both ends, and has a proximal end 101C communicating with the interior of the manhole P, and a distal end 101D located in a position external thereto, and elevated with respect to said manhole and communicating with the atmosphere, in order to define a path for the evacuation to the atmosphere of gas possibly escaping from the pipe T or valve VS toward the above mentioned manhole P.

It should also be noted that the ventilation box 102 may possibly be omitted, without thereby invalidating the spirit of the invention, if the distal end 101D of the vent duct 101 can be located in a safe position, sufficiently elevated and protected from atmospheric agents.

According to calculations carried out to quantify a sufficient air flow rate, the vent duct 101 preferably has an internal diameter of at least 63 millimeters and is made of a corrugated tube of plastic material of the type used for the passage of cables in electrical installations.

Furthermore, in order to comply with indications given by the regulations, the ventilation box 102 is located at least 3 meters from the ground.

The embodiment of the device 100, as illustrated, is based on the assumption that the above-mentioned column 7 is provided, therefore it is logical to envisage that the ventilation box 102 is also supported by the same column 7; consequently, the height of the latter is sufficient to place said ventilation box 102 at the above mentioned height from the ground.

In this case, said second length 101B of the ventilation duct 101 is advantageously inserted within said column 7 at least between the base of said column 7 and said ventilation box 102.

The shape of the ventilation box 102 is designed in such a way as to prevent rain from entering through the opening 105, by means of which the ventilation box communicates with the outside, and a grating 104 is also provided at the above mentioned opening 105, in order to prevent the entry of animals, leaves and/or debris.

An interesting constructive option, illustrated in the enclosed FIGURE, includes a spontaneously moving fan 106 arranged at the top of said ventilation box 102, capable of increasing the air extraction flow from said manhole P through said vent duct 101.

Alternatively, and for the same purpose, a motorized fan, not illustrated, can be provided, arranged within said ventilation box 102 and operated upon input from the above-mentioned electronic processing and control unit 3.

The device 100 is completed with at least one gas sensor 103, inserted in a predetermined position between said manhole P and the above-mentioned ventilation box 102, interfaced with said electronic processing and control unit 3 and powered via the above mentioned power supply module 6 of the system 1.

Preferably, as illustrated, the gas sensor 103 is situated inside the said vent duct 101, in proximity to the outlet thereof into the ventilation box 102.

However, it may be contemplated that the gas sensor 103 is arranged within the above-mentioned manhole P.

The gas sensor 103, as intuitively comprehensible, is intended to signal the possible presence of flammable gases or vapors in the monitored air volume to the electronic processing and control unit 3, so that the closing/opening manuever of above-mentioned ball valve Vs by said gear motor unit 2 is inhibited, so as to prevent the generation of sparks that could cause deflagration.

The receipt, by the electronic processing and control unit 3, of the information about the anomalous presence of flammable gas or vapors in the manhole P, as well as the consequent failure to maneuver the ball valve Vs, are then communicated to the remote operation center 5 by the transceiver apparatus 4, so that an intervention plan is prepared on site.

The device 100 described above makes it possible to validate the system 1 no longer in risk class “0” but, much more conveniently, in risk class “2”, according to the current ATEX regulations briefly mentioned in the introductory note. Furthermore, depending on the materials and devices, both of which are known to a person skilled in the field, that can be used for the construction of the electrical and electronic components residing in the manhole (P), in the ventilation box 102 or in the vent duct 101, the environment manhole-vent duct-ventilation box, as well as the space immediately outside the manhole, can even be considered a “safe space”, in that it is in no way subject to the risk of accumulation of explosive substances.

This statement is already considered well-supported, however, certifying engineers are expected to prepare, later on, a complete technical report in which all the regulatory aspects in force will be duly taken into account in order to better investigate and support such a prior evaluation.

Of course, the purely bureaucratic aspect of the matter, i.e., certification in a certain risk class, does not at all set aside the importance of the substantive requirement, i.e., the improved safety offered when installing the system thanks to the device described above.

It must be said that the mere presence of the vent duct and ventilation box, in all likelihood, would allow to obtain the more favorable risk class “1” instead of the worst one (class “0”), but the gas sensor and its interaction with the operation of the system aimed at inhibiting the operation of the ball valve, have advantageously avoided any risk of detonation and, therefore, made it possible to fall in the risk class “2”, or even safe space, and therefore outside the ATEX prediction and requirements.

As can easily be seen, the proposed device is technically simple, functionally effective, and is very suitable for the given installation conditions since it can function properly without the need for frequent maintenance.

The constructive simplicity of the described device allows to contain the costs for its production in such a way that they do not significantly affect the total cost of the system and its installation on site.

However, it is understood that what is described above is illustrative and not limiting, therefore any detail variations that may be necessary for technical and/or functional reasons are considered from now on within the same protection scope defined by the claims below.

1. A device (100) comprising equipment for preventing accumulation of flammable fluid inside an underground manhole (P) housing a line valve installed in a pipeline (T) of a network for the transport of said flammable fluid, wherein motorized opening and closing of said line valve is controlled by a gear motor unit (2); said equipment including an electronic processing and control unit (3), suitable for determining operation of said geared motor unit (2), according to predefined modes; a transceiver apparatus (4), interfaced with said electronic processing and control unit (3) for communicating with a remote operation center (5), said equipment also including:
a vent duct (101) having a proximal end (101C) communicating with the inside of the manhole (P) in which said valve (Vs) is installed, and a distal end (101D) placed in a position external to said manhole (P), and elevated with respect to said manhole and communicating with atmosphere above said underground manhole, in order to define a path for the evacuation to the atmosphere of gas possibly escaping from said pipe (T) or valve (VS) to said inside the underground manhole (P);
at least one gas sensor (103), inserted in said vent duct (101), at a predetermined position between said proximal end (101C) and distal end (101D) thereof, interfaced with said electronic processing and control unit (3) and configured to provide a sensed signal to indicate presence of flammable gas or vapors in the vent duct to said electronic processing and control unit for inhibiting operation of said valve (Vs) by said gear motor unit (2).

2. The device (100) according to claim 1, comprising a ventilation box, (102) for communicating with the atmosphere and placed in correspondence to the distal end (101D) of said vent duct (101).

3. The device (100) according to claim 1, wherein said gas sensor (103) is placed inside said vent duct (101), in a predetermined position between said proximal end (101C) and distal end (101D) thereof.

4. The device (100) according to claim 1, wherein said gas sensor (103) is placed inside said manhole (P).

5. The device (100) according to claim 2, wherein said gas sensor (103) is placed inside said ventilation box (102).

6. The device (100) according to claim 2, associated with a system (1) in which said electronic processing and control unit (3) and said transceiver apparatus (4) are supported by a column (7), wherein said ventilation box (102) is in turn associated with and supported by said column (7), and wherein said vent duct (101) is inserted into said column (7) at least for a length (101B) included between-said base a base of said column and said ventilation box (102).

7. The device (100) according to claim 2, wherein said ventilation box (102) has such a shape that prevents rain from entering through an opening (105) by means of which said ventilation box (102) communicates with the atmosphere, and wherein a grating (104) is provided in a region of said opening (105), in order to prevent animals, leaves, or debris from entering said ventilation box (102).

8. The device (100) according to claim 1, further comprising a spontaneously moving fan (106) situated on top of said ventilation box (102), and capable of increasing a flow of air extraction from said manhole (P) through said vent duct (101).

9. The device (100) according to claim 1, further comprising a motorized fan, arranged inside said ventilation box (102), operable upon input of said electronic processing and control unit (3), to increase a flow of air extracted from said manhole (P) through said vent duct (101).
